(19) United States
(12) Patent Application Publication
(10) Pub. No.: US 2026/0149059 A1
(43) Pub. Date: May 28, 2026

(54) BATTERY

(71) Applicant: Murata Manufacturing Co., Ltd., Nagaokakyo-shi (JP)

(72) Inventor: Yusuke MORINO, Nagaokakyo-shi (JP)

(21) Appl. No.: 19/456,164

(22) Filed: Jan. 22, 2026

Related U.S. Application Data
(63) Continuation of application No. PCT/JP2024/021734, filed on Jun. 14, 2024.

(30) Foreign Application Priority Data
Aug. 8, 2023 (JP) 2023-129540

(51) Int. Cl. H01M 10/42; H01M 4/02; H01M 4/134; H01M 4/38; H01M 10/0525; H01M 10/0562

(52) U.S. Cl. CPC H01M 10/4235; H01M 4/134; H01M 4/386; H01M 4/387; H01M 10/0525; H01M 10/0562; H01M 2004/021; H01M 2004/027

(57) ABSTRACT

A battery that includes: a positive electrode; a negative electrode including a negative electrode active material layer containing a negative electrode active material and particles having insulating property; and an electrolyte layer containing a solid electrolyte between the positive electrode layer and the negative electrode layer. The negative electrode active material layer includes a first principal surface on a first side of the electrolyte layer and a second principal surface on a second side opposite to the first principal surface. In the negative electrode active material layer, the negative electrode active material is continuous from the first principal surface to the second principal surface. The particles are on the first principal surface of the negative electrode active material layer.

### CROSS REFERENCE TO RELATED APPLICATIONS

The present application is a continuation of International application No. PCT/JP2024/021734, filed Jun. 14, 2024, which claims priority to Japanese Patent Application No. 2023-129540, filed Aug. 8, 2023, the entire contents of each of which are incorporated herein by reference.

### TECHNICAL FIELD

The present disclosure relates to a battery.

### BACKGROUND ART

Patent Document 1 describes an all-solid-state battery including fine particles containing a sulfide-based solid electrolyte at a boundary between a solid electrolyte layer and a negative electrode layer.
Patent Document 1: Japanese Patent No. 6204671

### SUMMARY OF THE DISCLOSURE

However, in the battery described in Patent Document 1, there is a possibility that the solid electrolyte is reduced and decomposed by a side reaction of a charge-discharge reaction, and the discharge capacity is lowered.

The present disclosure has been made in view of the foregoing, and an object thereof is to improve the discharge capacity.

A battery according to an aspect includes: a positive electrode; a negative electrode including a negative electrode active material layer containing a negative electrode active material and particles having insulating property; and an electrolyte layer containing a solid electrolyte between the positive electrode layer and the negative electrode layer, in which the negative electrode active material layer includes a first principal surface on a first side of the electrolyte layer and a second principal surface on a second side opposite to the first principal surface, in the negative electrode active material layer, the negative electrode active material is continuous from the first principal surface to the second principal surface, and the particles are on the first principal surface of the negative electrode active material layer.

According to the present disclosure, the discharge capacity can be improved.

### BRIEF EXPLANATION OF THE DRAWING

The FIGURE is a schematic sectional view illustrating an example of a battery according to a first embodiment.

### DESCRIPTION OF THE PREFERRED EMBODIMENTS

Hereinafter, an embodiment of the present disclosure will be described. Note that the present disclosure is not limited by the embodiments.

### First Embodiment

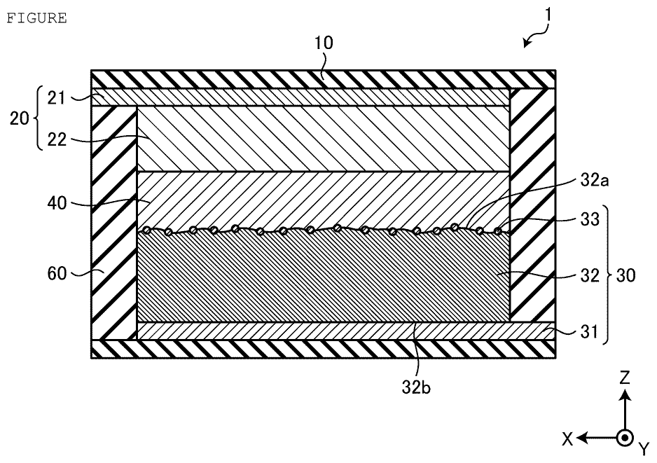

The FIG. 1s a schematic sectional view illustrating an example of a battery according to a first embodiment. A battery 1 in the first embodiment is an all-solid-state battery in which an electrolyte is solid, and is a lithium ion secondary battery. As illustrated in the FIGURE, the battery 1 includes a protective layer 10, a positive electrode 20, a negative electrode 30, and an electrolyte layer 40. In the example of the FIGURE, the battery 1 has a structure in which the positive electrode 20, the negative electrode 30, and the electrolyte layer 40 are stacked.

In the drawings illustrating the present embodiment, a Z direction refers to a stacking direction of the positive electrode 20, the negative electrode 30, and the electrolyte layer 40, an X direction refers to a direction orthogonal to the Z direction and parallel to the section of the FIGURE, and a Y direction refers to a direction orthogonal to the X direction and the Z direction. In the description of the present embodiment, one of the X directions may be described as the +X direction, and the other may be described as the −X direction. Similarly, in the Z direction, one direction may be described as the +Z direction and the other direction may be described as the −Z direction.

The protective layer 10 is a layer provided to physically and chemically protect the battery 1. The protective layer 10 is provided so as to overlap the stack of the positive electrode 20, the negative electrode 30, and the electrolyte layer 40, in a plan view in the Z direction, and is provided on both sides in the Z direction of the stack of the positive electrode 20, the negative electrode 30, and the electrolyte layer 40 in the example of the FIGURE. The material of the protective layer 10 is not particularly limited as long as it is an insulating body, and is, for example, resin, glass, ceramics, or the like.

The positive electrode 20 includes a positive electrode current collector layer 21 and a positive electrode active material layer 22. In the example of the FIGURE, the positive electrode 20 has a structure in which the positive electrode active material layer 22 is stacked in the −Z direction of the positive electrode current collector layer 21, but this is merely an example, and the positive electrode active material layer 22 may be stacked in the +Z direction of the positive electrode current collector layer 21.

The positive electrode current collector layer 21 is a layer having conductivity. In the example of the FIGURE, the positive electrode current collector layer 21 has an exposed end surface in the +X direction, and can be connected to the outside. That is, the end surface of the positive electrode current collector layer 21 in the +X direction is a plus electrode of the battery 1. The material of the positive electrode current collector layer 21 is not particularly limited as long as it has conductivity, and examples thereof include metal materials such as silver, palladium, gold, platinum, aluminum, copper, and nickel, and carbon materials.

The positive electrode active material layer 22 is a layer containing a positive electrode active material. The positive electrode active material layer 22 is stacked on the positive electrode current collector layer 21. The positive electrode active material is not particularly limited, and examples thereof include at least one selected from the group consisting of a lithium-containing phosphate compound having a NASICON-type structure, a lithium-containing phosphate compound having an olivine-type structure, a lithium-containing layered oxide, a lithium-containing oxide having a spinel-type structure, and the like. Examples of the lithium-containing phosphate compound having a NASICON-type structure include Li₃V₂(PO₄)₃. Examples of the lithium-containing phosphate compound having an olivine-type structure include Li₃Fe₂(PO₄)₃ and LiMnPO₄. Examples of the lithium-containing layered oxide include LiCoO₂ and LiCO_{1/3}Ni_{1/3}Mn_{1/3}O₂. Examples of the lithium-containing oxide having a spinel-type structure include LiMn₂O₄ and LiNi_{0.5}Mn_{1.5}O₄.

The material contained in the positive electrode active material layer 22 is not limited to the positive electrode active material, and may contain a solid electrolyte or a sintering aid described later. The sintering aid is not particularly limited, and examples thereof include lithium oxide, sodium oxide, potassium oxide, boron oxide, silicon oxide, bismuth oxide, and phosphorus oxide.

The negative electrode 30 includes a negative electrode current collector layer 31, a negative electrode active material layer 32, and particles 33.

The negative electrode current collector layer 31 is a layer having conductivity. Here, in the example of the FIGURE, the negative electrode current collector layer 31 has an exposed end surface in the −X direction, and can be connected to the outside. That is, the end surface of the negative electrode current collector layer 31 in the −X direction is a minus electrode of the battery 1. The material of the negative electrode current collector layer 31 is a conductive metal and contains at least one or more metals of copper, nickel, and iron. The material of the negative electrode current collector layer 31 is not limited thereto, and may further contain, for example, a metal material such as palladium, gold, platinum, or aluminum. The negative electrode current collector layer 31 is not limited to one layer, and may include a plurality of layers such as stainless steel in which the negative electrode active material layer 32 side is coated with nickel.

The negative electrode active material layer 32 is a layer containing a negative electrode active material. In the example of the FIGURE, the negative electrode active material layer 32 is provided in the +Z direction of the negative electrode current collector layer 31. As illustrated in the FIGURE, the negative electrode active material layer 32 includes a first principal surface 32a and a second principal surface 32b. The first principal surface 32a is a principal surface of the negative electrode active material layer 32 on the electrolyte layer 40 side. The second principal surface 32b is a principal surface of the negative electrode active material layer 32 on a side opposite to the electrolyte layer 40. In the example of the FIGURE, the second principal surface 32b is in contact with the negative electrode current collector layer 31.

The thickness of the negative electrode active material layer 32 is 10 μm or more. Here, the thickness of the negative electrode active material layer 32 refers to an average of distances between the first principal surface 32a and the second principal surface 32b in a direction (Z direction) in which the negative electrode current collector layer 31 and the electrolyte layer 40 face each other. Thereby, the energy density of the battery 1 can be improved.

The negative electrode active material layer 32 contains at least one of tin (Sn) and silicon (Si) as a negative electrode active material. The crystallinity of silicon is not particularly limited, and may be, for example, amorphous. Thereby, the energy density of the battery 1 can be improved. In the present embodiment, the negative electrode active material layer 32 contains a negative electrode active material, but may further contain a conduction aid or a binder.

In the negative electrode active material layer 32, the negative electrode active material is continuous from the first principal surface 32a to the second principal surface 32b. In other words, the negative electrode active material layer 32 contains substantially no component (for example, a solid electrolyte) of the electrolyte layer 40. In other words, in the negative electrode active material layer 32, there is a path from the principal surface on the negative electrode current collector layer 31 side to the principal surface on the electrolyte layer 40 side through only the negative electrode active material. Examples of the continuous body include a metal foil and a wafer, but may have a coating formed by plating, sputtering, vapor deposition, or the like. Thereby, the energy density of the battery 1 can be improved. When the particles 33 including an insulating body enter between particles of the negative electrode active material, it is possible to suppress the inhibition of the electron conduction path from the negative electrode current collector layer 31 to the electrolyte layer 40.

Note that, when the negative electrode active material layer 32 includes a plurality of negative electrode active material particles, the particles are in direct contact with each other so that ions or electrons are mechanistically conducted through the negative electrode active material particles, and the first principal surface 32a side and the second principal surface 32b side are electrically connected by the contact. That is, the plurality of negative electrode active material particles are formed from the first principal surface 32a to the second principal surface 32b.

Here, the term “continuous” means that when a straight line connecting the first principal surface 32a and the second principal surface 32b along the Z direction is drawn, there is no component (including a gap) other than the active material on the straight line. More specifically, in at least one field of view in an observation image obtained by observing the section of the negative electrode active material layer 32 with an electron microscope such as a SEM, when the area of the region where the straight line is drawn is 50% or more with respect to the total area of the section of the negative electrode active material layer 32, it can be said that the negative electrode active material is continuous from the first principal surface 32a to the second principal surface 32b in the negative electrode active material layer 32.

The particles 33 are particles dispersed on the first principal surface 32a of the negative electrode active material layer 32. In the example of the FIGURE, the particles 33 are in contact with the negative electrode active material layer 32 and the electrolyte layer 40. Here, “being dispersed” means that the particles are scattered on the first principal surface 32a and are disposed on a part of the first principal surface 32a. In other words, the first principal surface 32a includes a region in contact with the electrolyte layer 40 via the particles 33 and a region in direct contact with the electrolyte layer 40. The primary particle size of the particles 33 is preferably 100 nm or less. The primary particle size refers to the median diameter (D₅₀ particle size) of particles. Thereby, the particles 33 easily bite into the negative electrode current collector layer 31 and the electrolyte layer 40, and separation between the negative electrode current collector layer 31 and the electrolyte layer 40 can be suppressed by an anchor effect. The primary particle size of the particles 33 can be measured from a scanning electron microscope (SEM) observation image or an energy dispersive X-ray spectroscopy (EDX) mapping image.

The particles 33 have insulating property. “Having insulating property” means that the ionic conductivity is 10⁻⁷ S/cm or less and the electronic conductivity is 10⁻⁷ S/cm or less at normal temperature, that is, 5° C. to 35° C. Thereby, an area where the negative electrode active material layer 32 and the electrolyte layer 40 are in contact with each other is reduced, so that it is possible to suppress reductive decomposition of the solid electrolyte due to a side reaction of the charge-discharge reaction and to improve the discharge capacity. Since the electron conduction from the negative electrode current collector layer 31 to the electrolyte layer 40 can be improved by a dielectric effect, resistance at an interface between the negative electrode current collector layer 31 and the electrolyte layer 40 can be reduced, and the coulombic efficiency can be improved.

The particles 33 include an insulating body, and preferably include a charged insulating body. The charged insulating body refers to a material that insulates ions and electrons. The particles 33 are inorganic compounds having an element M and oxygen (O). The element M is at least one of calcium (Ca), barium (Ba), titanium (Ti), zirconium (Zr), vanadium (V), niobium (Nb), molybdenum (Mo), manganese (Mn), iron (Fe), cobalt (Co), nickel (Ni), copper (Cu), zinc (Zn), aluminum (Al), indium (In), silicon (Si), tin (Sn), antimony (Sb), and phosphorus (P). Thereby, the dielectric effect is improved, so that the resistance at the interface between the negative electrode current collector layer 31 and the electrolyte layer 40 can be further reduced.

The electrolyte layer 40 is a layer provided between the positive electrode 20 and the negative electrode 30. The electrolyte layer 40 is a sintered body containing a solid electrolyte. The solid electrolyte is not particularly limited as long as it is a material in which ions can move between the positive electrode 20 and the negative electrode 30. The solid electrolyte is, for example, a sulfide, and Li₆PS₅Cl, Li₃PS₄, Li₄SnS₄, or the like is used. By using the sulfide solid electrolyte, the thermoformability of the electrolyte layer 40 can be improved, and a favorable bonding interface with the positive electrode active material layer 22 can be formed.

A side surface reinforcing portion 60 is provided to prevent a short circuit of the battery 1. In the example of the FIGURE, the side surface reinforcing portion 60 is provided on end surfaces in the X direction and the Y direction of the positive electrode 20, the negative electrode 30, and the electrolyte layer 40. The material of the side surface reinforcing portion 60 is not particularly limited as long as it is an insulating body, and is, for example, resin, glass, or ceramics.

Note that the negative electrode and the battery according to the first embodiment are not limited to those described above. For example, when the negative electrode active material layer is a metal foil, the negative electrode may not include the negative electrode current collector layer. In this case, the negative electrode active material layer can be connected to the outside as a negative electrode of the battery.

The battery according to the first embodiment may be a battery including an exterior body (case). That is, the battery according to the first embodiment may be a battery in which a stack including the positive electrode 20, the negative electrode 30, and the electrolyte layer 40 is housed in an exterior body formed of metal, ceramics, or the like.

As described above, the battery 1 according to the present embodiment includes the positive electrode 20, the negative electrode 30 including the negative electrode active material layer 32 containing a negative electrode active material and the particles 33 having insulating property, and the electrolyte layer 40 containing a solid electrolyte. The negative electrode active material layer 32 includes the first principal surface 32a on a side of the electrolyte layer 40 and the second principal surface 32b on a side opposite to the first principal surface. In the negative electrode active material layer 32, the negative electrode active material is continuous from the first principal surface 32a to the second principal surface 32b. The particles 33 are on the first principal surface 32a of the negative electrode active material layer 32.

Thereby, an area where the negative electrode active material layer 32 and the electrolyte layer 40 are in contact with each other is reduced, so that it is possible to suppress reductive decomposition of the solid electrolyte due to a side reaction of the charge-discharge reaction and to improve the discharge capacity. Since the electron conduction from the negative electrode current collector layer 31 to the electrolyte layer 40 can be improved by a dielectric effect, resistance at an interface between the negative electrode current collector layer 31 and the electrolyte layer 40 can be reduced, and the coulombic efficiency can be improved.

As a desirable aspect, the thickness of the negative electrode active material layer 32 is 10 μm or more. Thereby, the energy density of the battery 1 can be improved.

As a desirable aspect, the negative electrode active material contains at least one of Sn and Si. Thereby, the energy density of the battery 1 can be improved.

As a desirable aspect, the particles 33 contain oxygen. Thereby, the dielectric effect is improved, so that the resistance at the interface between the negative electrode current collector layer 31 and the electrolyte layer 40 can be further reduced, so that the coulombic efficiency can be further improved.

The particles 33 contain at least one of Ca, Ba, Ti, Zr, V, Nb, Mo, Mn, Fe, Co, Ni, Cu, Zn, Al, In, Si, Sn, and Sb. Also in this case, the discharge capacity can be improved.

The particles 33 contain at least one of titanium oxide, zirconium oxide, aluminum oxide, zinc oxide, indium oxide, barium titanate, and phosphorus oxide. Also in this case, the discharge capacity can be improved.

As a desirable aspect, the solid electrolyte contains sulfur. Thereby, the thermoformability of the electrolyte layer 40 can be improved, and a favorable bonding interface with the positive electrode active material layer 22 can be formed.

One example of the production method of the negative electrode according to the first embodiment will be described below. A method for synthesizing the negative electrode according to the first embodiment includes a negative electrode active material layer forming step and a particle dispersion step.

The negative electrode active material layer forming step is a step of forming the negative electrode active material layer 32. The negative electrode active material layer 32 is formed by, for example, rolling a metal foil so as to have a thickness of 10 μm or more.

The particle dispersion step is a step of dispersing the particles 33 on one principal surface of the negative electrode active material layer 32. Specifically, a solvent in which the particles 33 are dispersed is added dropwise onto one principal surface of the negative electrode active material layer 32 and dried, whereby the particles 33 are dispersed on one principal surface of the negative electrode active material layer 32. Here, when the negative electrode active material layer 32 is already provided on the negative electrode current collector layer 31, the particles 33 are dispersed on the principal surface of the negative electrode active material layer 32 on a side opposite to the negative electrode current collector layer 31 side.

Note that the method for producing the negative electrode described above is merely an example, and is not limited to the above. For example, in the negative electrode active material layer forming step, the negative electrode active material layer 32 may be formed by sputtering the negative electrode active material as a vapor deposition source on the negative electrode current collector layer 31. In this case, in the particle dispersion step, the particles 33 are dispersed on the principal surface of the negative electrode active material layer 32 on a side opposite to the negative electrode current collector layer 31 side.

### EXAMPLES

Hereinafter, Examples according to the present embodiment will be described. Note that the present embodiment is not limited to the following Examples.

### Example 1

A battery according to Example 1 was produced by the following method. As the negative electrode active material layer forming step, a tin foil was rolled so as to have a thickness of 10 μm, thereby producing a negative electrode active material layer. As the particle dispersion step, a solution in which zirconium oxide (ZrO₂) particles having a primary particle size of 10 nm were dispersed in isopropyl alcohol at 0.1 mass % was added dropwise at a dropping amount of 50 μL/cm² to the produced negative electrode active material layer, and was air-dried and then completely dried at 100° C. Thereafter, 50 mg of a powder of Li₆PS₅C as a solid electrolyte was compacted into pellets to produce an electrolyte layer. The produced electrolyte layer was attached to the side of the negative electrode active material layer with the particles produced above on which the particles were present. A counter electrode formed of an In—Li alloy was attached to a principal surface of the produced electrolyte layer on a side opposite to the negative electrode active material layer. Thereafter, a stainless steel foil was attached to both surfaces as a negative electrode current collector and a counter electrode current collector, and pressed in the stacking direction at a pressure of 1 tf/(cm²·min) to produce a battery according to Example 1.

In the measurement of the charge-discharge characteristics according to Example 1, the charge capacity and the coulombic efficiency were measured under the following conditions. Here, charging refers to inserting lithium ions into the negative electrode to store energy, and discharging refers to desorbing lithium ions from the negative electrode to release energy.
Charging rate: 0.05 C
Charging method: CCCV, 0.01 C current cut
Charge control voltage: 5 mV
Discharging rate: 0.05 C
Discharging method: CC
End-of-discharge voltage: 1.5 V

### Example 2

In Example 2, production of a battery and measurement of charge-discharge characteristics were performed in the same manner as in Example 1, except that in the particle dispersion step, aluminum oxide (Al₂O₃) particles having a primary particle size of 20 nm were used instead of zirconium oxide (ZrO₂) particles.

### Example 3

In Example 3, production of a battery and measurement of charge-discharge characteristics were performed in the same manner as in Example 1, except that in the particle dispersion step, indium oxide (In₂O₃) particles having a primary particle size of 50 nm were used instead of zirconium oxide (ZrO₂) particles.

### Example 4

In Example 4, production of a battery and measurement of charge-discharge characteristics were performed in the same manner as in Example 1, except that in the particle dispersion step, barium titanate particles (BaTiO₃) having a primary particle size of 80 nm were used instead of zirconium oxide (ZrO₂) particles.

### Example 5

In Example 5, production of a battery and measurement of charge-discharge characteristics were performed in the same manner as in Example 1, except that Li₃PS₄ was used as a solid electrolyte.

### Comparative Example 1

In Comparative Example 1, production of a battery and measurement of charge-discharge characteristics were performed in the same manner as in Example 1, except that in the particle dispersion step, a solution in which Li₆PS₅Cl particles having a primary particle size of 100 nm were dispersed in hexane at 1 mass % was used instead of the solution in which zirconium oxide (ZrO₂) particles were dispersed in isopropyl alcohol at 0.1 mass %.

### Comparative Example 2

In Comparative Example 2, production of a battery and measurement of charge-discharge characteristics were performed in the same manner as in Example 1, except that in the particle dispersion step, a solution in which Li₃PS₄ particles having a primary particle size of 100 nm were dispersed in hexane at 1 mass % was used instead of the solution in which zirconium oxide (ZrO₂) particles were dispersed in isopropyl alcohol at 0.1 mass %.

Table 1 shows the measurement results of the charge-discharge characteristics according to Examples 1 to 5 and Comparative Examples 1 and 2.

TABLE 1

| | | Negative | | | | | |
|---|---|---|---|---|---|---|---|
| | | electrode | | | | | |
| | | active | | | | | |
| | Negative | material | | Primary | | | |
| | electrode | layer | | particle | | Discharge | Coulombic |
| | active | thickness | | size | Solid | capacity | efficiency |
| | material | (μm) | Particle | (nm) | electrolyte | (mAh/g) | (%) |
| Example 1 | Sn | 10 | ZrO₂ | 10 | Li₆PS₅Cl | 420 | 60 |
| Example 2 | | | Al₂O₃ | 20 | | 427 | 61 |
| Example 3 | | | In₂O₃ | 50 | | 441 | 63 |
| Example 4 | | | BaTiO₃ | 80 | | 427 | 61 |
| Example 5 | | | ZrO₂ | 10 | Li₃PS₄ | 427 | 61 |
| Comparative | | | Li₆PS₅Cl | 100 | Li₆PS₅Cl | 395 | 57 |
| Example 1 | | | | | | | |
| Comparative | | | Li₃PS₄ | 100 | | 399 | 58 |
| Example 2 | | | | | | | |

As shown in Table 1, in Example 1-5, since particles having insulating property were used, the discharge capacity and the coulombic efficiency were improved as compared with Comparative Examples 1 and 2 using particles having ion conductivity.

### Example 6

In Example 6, production of a battery and measurement of charge-discharge characteristics were performed in the same manner as in Example 1, except that as the negative electrode active material layer forming step, a tin foil was rolled so as to have a thickness of 20 μm.

### Comparative Example 3

In Comparative Example 3, production of a battery and measurement of charge-discharge characteristics were performed in the same manner as in Comparative Example 1, except that as the negative electrode active material layer forming step, a tin foil was rolled so as to have a thickness of 20 μm.

Table 2 shows the measurement results of the charge-discharge characteristics according to Example 6 and Comparative Example 3.

TABLE 2

| | | Negative | | | | | |
|---|---|---|---|---|---|---|---|
| | | electrode | | | | | |
| | | active | | | | | |
| | Negative | material | | Primary | | | |
| | electrode | layer | | particle | | Discharge | Coulombic |
| | active | thickness | | size | Solid | capacity | efficiency |
| | material | (μm) | Particle | (nm) | electrolyte | (mAh/g) | (%) |
| Example 6 | Sn | 20 | ZrO₂ | 10 | Li₆PS₅Cl | 315 | 45 |
| Comparative | | | Li₆PS₅Cl | 100 | | 302 | 42 |
| Example 3 | | | | | | | |

As shown in Table 2, even when the thickness of the negative electrode active material layer was 20 μm, in Example 6, since particles having insulating property were used, the discharge capacity and the coulombic efficiency were improved as compared with Comparative Example 3 using particles having ion conductivity.

### Example 7

In Example 7, as the negative electrode active material layer forming step, sputtering was performed using Si as a vapor deposition source on a copper foil having a thickness of 20 μm to form a Si film having a thickness of 12 μm, thereby producing a negative electrode active material layer. Sputtering was performed in an argon atmosphere at 0.7 Pa using Si as a vapor deposition source by magnetron sputtering. In the particle dispersion step, a solution in which zirconium oxide (Zro₂) particles having a primary particle size of 10 nm were dispersed in isopropyl alcohol at 0.1 mass % was added dropwise at a dropping amount of 50 μL/cm² to the Si film side of the copper foil, and was air-dried and then completely dried at 100° C. In all the subsequent steps, a battery was produced in the same manner as in Example 1, and charge-discharge measurement was performed under the same conditions as in Example 1.

### Example 8

In Example 8, production of a battery and measurement of charge-discharge characteristics were performed in the same manner as in Example 7, except that in the particle dispersion step, indium oxide particles having a primary particle size of 50 nm were used as particles instead of zirconium oxide (Zro₂) particles.

### Comparative Example 4

In Comparative Example 4, production of a battery and measurement of charge-discharge characteristics were performed in the same manner as in Example 7, except that in the particle dispersion step, a solution in which Li₆PS₅Cl particles having a primary particle size of 100 nm were dispersed in hexane at 1 mass % was used instead of the solution in which zirconium oxide (Zro₂) particles were dispersed in isopropyl alcohol at 0.1 mass %.

Table 3 shows the measurement results of the charge-discharge characteristics according to Examples 7 and 8 and Comparative Example 4.

TABLE 3

| | | Negative | | | | | |
|---|---|---|---|---|---|---|---|
| | | electrode | | | | | |
| | | active | | | | | |
| | Negative | material | | Primary | | | |
| | electrode | layer | | particle | | Discharge | Coulombic |
| | active | thickness | | size | Solid | capacity | efficiency |
| | material | (μm) | Particle | (nm) | electrolyte | (mAh/g) | (%) |
| Example 7 | Si | 12 | ZrO₂ | 10 | Li₆PS₅Cl | 2480 | 92 |
| Example 8 | | | In₂O₃ | 50 | | 2510 | 93 |
| Comparative | | | Li₆PS₅Cl | 100 | | 2430 | 90 |
| Example 4 | | | | | | | |

As shown in Table 3, even when Si was used as a negative electrode active material, in Examples 7 and 8, since particles having insulating property were used, the discharge capacity and the coulombic efficiency were improved as compared with Comparative Example 4 using particles having ion conductivity.

Note that the embodiments described above are intended to facilitate understanding of the present disclosure, but not intended to construe the present disclosure in any limited way. The present disclosure may be modified or improved without departing from the spirit thereof, and the present disclosure includes equivalents thereof. disclosure

### DESCRIPTION OF REFERENCE SYMBOLS

1: Battery
10: Protective layer
20: Positive electrode
21: Positive electrode current collector layer
22: Positive electrode active material layer
30: Negative electrode
31: Negative electrode current collector layer
32: Negative electrode active material layer
32a: First principal surface
32b: Second principal surface
33: Particle
40: Electrolyte layer
60: Side surface reinforcing portion

1. A battery comprising:
a positive electrode;
a negative electrode including a negative electrode active material layer containing a negative electrode active material and particles having insulating property; and
an electrolyte layer containing a solid electrolyte between the positive electrode layer and the negative electrode layer, wherein
the negative electrode active material layer includes a first principal surface on a first side of the electrolyte layer and a second principal surface on a second side opposite to the first principal surface,
in the negative electrode active material layer, the negative electrode active material is continuous from the first principal surface to the second principal surface, and
the particles are on the first principal surface of the negative electrode active material layer.

2. The battery according to claim 1, wherein the negative electrode active material layer has a path from the first principal surface to the second principal surface through only the negative electrode active material.

3. The battery according to claim 1, wherein the negative electrode active material layer includes a metal foil.

4. The battery according to claim 1, wherein a thickness of the negative electrode active material layer is 10 μm or more.

5. The battery according to claim 1, wherein the negative electrode active material contains at least one of Sn and Si.

6. The battery according to claim 1, wherein the negative electrode active material consists of Sn or Si.

7. The battery according to claim 1, wherein the particles contain oxygen.

8. The battery according to claim 5, wherein the particles contain at least one of Ca, Ba, Ti, Zr, V, Nb, Mo, Mn, Fe, Co, Ni, Cu, Zn, Al, In, Si, Sn, and Sb.

9. The battery according to claim 1, wherein the particles contain at least one of Ca, Ba, Ti, Zr, V, Nb, Mo, Mn, Fe, Co, Ni, Cu, Zn, Al, In, Si, Sn, and Sb.

10. The battery according to claim 1, wherein the particles contain at least one of titanium oxide, zirconium oxide, aluminum oxide, zinc oxide, indium oxide, barium titanate, and phosphorus oxide.

11. The battery according to claim 1, wherein the solid electrolyte contains sulfur.

12. The battery according to claim 1, wherein a primary particle size of the particles is 100 nm or less.

13. The battery according to claim 1, wherein the particles are in contact with the negative electrode active material layer and the electrolyte layer.

14. The battery according to claim 1, wherein the particles are scattered on the first principal surface.

15. The battery according to claim 1, wherein the first principal surface includes a first region in contact with the electrolyte layer via the particles and a second region in direct contact with the electrolyte layer.

16. The battery according to claim 1, wherein the particles are only on the first principal surface of the negative electrode active material layer.

17. The battery according to claim 16, wherein the first principal surface includes a first region in contact with the electrolyte layer via the particles and a second region in direct contact with the electrolyte layer.
